(19) United States
(12) Patent Application Publication
(10) Pub. No.: US 2016/0142538 A1
(43) Pub. Date: May 19, 2016

(54) METHOD FOR COMPENSATING FOR HEARING LOSS IN A TELEPHONE SYSTEM AND IN A MOBILE TELEPHONE APPARATUS

(71) Applicant: MECATHERM, Moscow (RU)

(72) Inventors: Aleksandr Yurevich BREDIKHIN, Moscow (RU); Maksim Iosifovich VASHKEVICH, Minsk (BY); Ilya Sergeevich AZAROV, Minsk (BY); Aleksandr Aleksandrovich PETROVSKY, Minsk (BY)

(21) Appl. No.: 14/894,958

(22) PCT Filed: Apr. 23, 2014
(86) PCT No.: PCT/RU2014/000297

§ 371 Date: Jan. 27, 2016

(30) Foreign Application Priority Data
May 31, 2013 (RU) 2013125243

(51) Int. Cl. H04M 3/42

(52) U.S. Cl. CPC H04M 3/42391

(57) ABSTRACT

The method makes it possible to extend functional possibilities, and to increase sound quality and the intelligibility of speech in mobile telephone apparatuses and communication systems for hearing-impaired subscribers. The personalized audio signals for hearing-impaired users are generated on the basis of attributes thereof received from audiograms—frequency characteristics of the hearing of the hearing-impaired user stored in a database on the server of the communications network and linked to the telephone numbers of hearing-impaired users. The signals are processed on the server in a broadband frequency range on the basis of attributes of the hearing of the hearing-impaired user, the power of the processed audio signals is adjusted according to the attributes of the hearing-impaired user, and the adjusted personalized audio signals are transmitted from the communication server to the telephone apparatuses of the hearing-impaired users.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

1. Field of the Invention

The invention relates to computer engineering and telecommunications systems and may be used for improving speech intelligibility for hearing-impaired users (suffering from sensorineural hearing loss).

2. Description of Related Art Including Information Disclosed Under 37 CFR 1.97 and 37 CFR 1.98.

People suffering from sensorineural hearing loss usually have an elevated level of acoustic information perception, which prevents them from hearing low-intensity sounds. However, loud sound perception is frequently at the same level as in normal people. Hearing perception loss threshold is frequency-dependent and is determined at specified frequencies (200; 500; 1,000; 2,000; 3,000; 4,000; and 6,000 Hz) by using clear tone signals for each patient.

The task of improving intelligibility for hearing-impaired people includes assembling the dynamic range of speech and day-to-day sounds into a limited dynamic range of impaired hearing. This method of compressing the dynamic range represents reflection of an audible range signal into the residual perception area of a patient. However, in this case an amplified signal should not be greater than a maximum level, since, otherwise, it would cause painful sensations in a person. Moreover, impaired hearing is usually frequency-dependent, i.e., a compressor should withstand various dynamic levels in a variety of frequency bands. Generally, this task may be solved by applying multi-channel systems, such as filter banks, with a different compression level in every channel. While designing a multi-channel compressor for a dynamic range, it is required:

1) to find a balance between frequency resolution and time delay. In common solutions, an increase in analysis frequency resolution leads to an increase in signal processing time;

2) to match frequency resolution of a multi-channel compressor for a dynamic range with frequency resolution of acoustic information perception by a person to a maximum degree possible;

3) to find a balance between frequency resolution and group delay. A delay in processing a signal in a multi-channel compressor having an unequal-band filter bank would be greater in a low-frequency band than in high-frequency channels, but it would be less than in equal-band systems having similar frequency resolution. At a great delay (more than 8 milliseconds), a parasitic echo appears that negatively affects perception, and intelligibility becomes worse.

There is a known method of improving speech intelligibility in digital telecommunication systems for users suffering from sensorineural hearing loss which is based on usage of a hearing aid (HA) and a mobile phone set (PS), wherein a user, in order to receive a signal from a PS, should bring it to his HA. (A. Boothroyd, K. Fitz, J. Kindred, etc. Hearing aids and wireless technology, The Hearing Review, March 2008). However, when this method is used, problems with both acoustic compatibility and electromagnetic compatibility of these two units arise. Providing acoustic compatibility conditions the necessity of changing gain in the PS loudspeakers and microphone sensitivity in the HA, all of which may lead to generation of acoustic feedback within the system and, as a consequence, to lowering of speech intelligibility, and, at certain gain and microphone sensitivity levels, to painful sensations in the user.

For example, a special standard for checking mutual compatibility between various types of HAs and mobile PSs has been developed in the U.S. Nowadays, a HA is often supplemented with an additional self-powered device communicating with the HA via a wireless link, e.g., Bluetooth (Yanz J. L. Phones and hearing aids: issues, resolutions, and a new approach. Hearing Journal, 2005, 58(10), pp. 41-48). This enables separating an HA and a PS by a certain distance, while excluding the problem of acoustic and electromagnetic compatibility of the two devices. However, a drawback of this method is that an additional device, i.e., a signal relay device between the HA and the PS, is required.

Also, there is another known method of improving speech intelligibility in digital telecommunication systems for hearing-impaired users that is based on an HA with an embedded wireless communication link. (R. Dong, D. Hermann, R. Brennan, E. Chau, Joint filter bank structures for integrating audio coding into hearing aid applications.—ICASSP-2008,—pp. 1533-1536). This method comprises: formation of an input audio signal by mixing a signal from a microphone with an audio signal received via a wireless communication link from a remote terminal (i.e., a TV-set, a multimedia player, another HA having a wireless communication link, and other audio signal sources provided with embedded wireless communication links); dynamic compression of an input audio signal including forming sub-band audio signals and controlling signal levels in respective sub-bands for the purpose of providing required dynamics of sub-band signal levels conditioned by an HA user audiogram, and subsequently restoring the audio signal by using synthesis filter banks. The advantage of this analogous solution with an embedded wireless communication link is that it can exclude negative influence of noise background and reverberation in a room on speech intelligibility for the HA user while receiving an audio signal from a remote terminal. There exists a possibility of connecting users to an HA network that is not susceptible to influence exerted by an acoustic environment existing in a room, and translating, e.g., emergency messages. The drawback here is the greater complexity and cost of an HA, short range of communication, and increased power consumption of an HA. But the principal limitation of this method is that the organization of HA user communication through a PS presupposes that, substantially, the method disclosed in the first analogous solution with all its drawbacks is used, posing the problems of both acoustic compatibility and electromagnetic compatibility between an HA and a PS.

There is a personal communication device that comprises a transmitter and a receiver for transmission and reception of communication signals encoding audio signals, an audio converter for making an audio signal audible, a microphone, and a control circuit connected to the transmitter, the receiver, the audio converter and the microphone, and comprising logic, applying multi-band compression to audio signals, including generation of parameters for the multi-band compression on the basis of stored user data and on the basis of environmental data set while controlling the converter making audio signals audible.

This device is able to maintain three sub-profiles: a user audio profile that is stored and received, inter alia, with the use of remote means having the possibility of transmitting an audio profile to the device; a user personal preference profile; data on the environment, i.e., a surrounding noise profile, any combination of which may be applied to an audio signal received after decoding a communication signal fed to the device receiver (U.S. Pat. No. 7,529,545). Drawbacks of this device are:
impossibility for the device user to use a personalized audio signal required during personal communication with a human interlocutor;
lack of the possibility for the device user of receiving a personalized audio signal while the user communicates with another subscriber via the phone and with an interlocutor in person; while an audio signal is received from loudspeakers of multiple devices, e.g., during watching TV, listening to music, etc.;
impossibility for hearing-impaired communication network subscribers, who do not possess such devices, to receive a personalized audio signal directly from such communication networks, in particular, when a user of this device communicates with another hearing-impaired communication network subscriber, who does not possess a similar device;
impossibility for a user of this device to use various modes according to his/her preferences, such as telephone conversation, communication with an interlocutor in person, reception of an audio signal from loudspeakers of various devices.

The closest to the method claimed herein is a method of compensating for impaired hearing in a telephone system, which is based on phone number resolution (U.S. Pat. No. 6,061,431). This method forms a personalized audio signal for hearing-impaired users on the basis of their attributes received from their audiograms stored in a database and bound to phone numbers of hearing-impaired users.

This method may be implemented in a communication network consisting of a PS of a close user (subscriber) and a remote user, devices enabling access to the PS data network, and an automatic phone exchange being the network server where a database of hearing-impaired subscriber attributes, applications for processing close and remote subscriber signals, a system for selecting attributes according to the number of an impaired hearing user are located. The communication server processes audio signals in a broadband frequency range on the basis of a function that is inverse to the frequency response of a hearing-impaired user, amplifies and/or limits power of processed audio signals in accordance with a function that is inverse to the frequency response of hearing of a hearing-impaired user for the purpose of maintaining a moderate volume, transmits amplified and/or limited personalized audio signals from the communication server to telephone apparatus of hearing-impaired users. Depending on who of the subscribers—close or remote—has impaired hearing, there are two options of the method implementation.

According to the first option, a remote subscriber has normal hearing, and a close subscriber has impaired hearing. In this case, the method of processing a speech signal consists in the following. A speech signal from a close subscriber is transmitted without processing through a network-enabled device to a network-enabled device in a remote subscriber's network and further to a PS of a remote subscriber. An audio signal of the remote subscriber is transmitted through the network-enabled device on the basis of the phone number of the hearing-impaired subscriber (i.e., the close subscriber) to the network server where it is processed by the server in the application module designed for processing a remote subscriber's signal according to the attributes contained in a close subscriber's audiogram that is selected from the attribute database in accordance with the close subscriber's phone number. Then, the processed remote subscriber's signal is transmitted through the network-enabled device, via the communication network, to the close subscriber's network-enabled device and further to the close subscriber's telephone apparatus.

According to the second option, a close subscriber and a remote subscriber have impaired hearing. In this case, the method of processing speech signals in a communication network may be implemented as follows. Audio signals (speech) from the close and remote subscribers are received, through corresponding network-enabled devices, on the network server where they are processed in corresponding application modules according to the audiogram attributes of the remote subscriber (for speech signal of the close subscriber) and the audiogram attributes of the close subscriber (for speech signal of the remote subscriber), which have been selected from the attribute database in accordance with the phone numbers of the remote subscriber and the close subscriber. Then, the processed signals are transmitted through the corresponding network-enabled devices to the subscribers' telephone apparatuses via the communication network.

One advantage of this method of compensating for impaired hearing is the possibility of forming a personalized audio signal for hearing-impaired users on the basis of processing a subscriber's speech signal in the network server according to attributes of a hearing-impaired user of a network, these attributes being stored in an attribute database at the communication network server and accessible for his phone number. A hearing-impaired user does not use his HA during a telephone conversation. Upon completion of a conversation, a hearing-impaired user may use his or her HA once again, which causes certain difficulties for him. The HA of a given user is the main instrument in his active life. At the same time, a hearing-impaired person experiences a number of difficulties with hearing aid, which are caused by the room acoustics, e.g., when perceiving sound from various multimedia devices, such as audio players, TV-sets, etc.

It should be said that this known method may not function in digital telephone networks. For example, a cellular phone network requires that additional decoding/encoding of audio signals should be implemented in the network server in order to obtain a signal in the form of pulse-code modulation (PCM) for processing signals from close and remote users. According to this method, users' signals are processed by a communication network server in a broadband frequency range on the basis of a function that is inverse to a hearing frequency response of a hearing-impaired person, as well as, in order to compensate for hearing loss, additional amplification, which is applied to a broadband signal, and an output signal power limiter may be activated to ensure moderate volume of an audio signal even in case where a user at the other end of the network speaks very loud. However, hearing-impaired people exhibit loss of frequency selectivity due to which it is required to process an audio signal in accordance with the psycho-acoustic scale and increase a signal-noise ratio in an audio signal received by a PS for maintaining a similar level of speech intelligibility when talking to a person having normal hearing. Speech intelligibility will be higher if frequency resolution of a dynamic range compressor is fully matched to that of acoustic information perception by a person, i.e., bark scale (J. M. Kates and K. H. Arehart, “Multichannel dynamic range compression using digital frequency warping”, EURASIP J. Adv. Sig. Proc, vol. 2005, no. 18, pp. 3003-3014, 2005).

Thus, the known method has the following drawbacks:
audio signal distortions and low speech intelligibility;
impossibility of forming a personalized audio signal enabling a user to listen to audio files, radio, etc.;
impossibility for a user to obtain a personalized signal necessary for his or her communication with a closely located interlocutor, while simultaneously receiving audio signals from loudspeakers of various devices;
impossibility for a hearing-impaired person to simultaneously maintain a conversation with a remote communication network subscriber and with a closely located interlocutor, while listening to audio signals from multimedia devices;
impossibility to use, as a network server, computer devices, with the exception of an automatic telephone exchange (ATE), which comprise a processor, a random-access memory unit, a long-term storage unit, and a device providing access to a communication network;
impossibility for a user of such device to use, according to his preferences, various modes, such as telephone conversation, personal communication with an interlocutor, reception of audio signals from loudspeakers of various devices.

### BRIEF SUMMARY OF THE INVENTION

The objective of the invention is to improve quality and performance.

The technical effect that may be obtained while carrying out the claimed method is expansion of functionality, improvement of sound quality and speech intelligibility in mobile phones and communication systems for hearing-impaired users.

In order to achieve the set objective and obtain the stated technical effect, the claimed technical solution proposes to use a cellular network as the communication network and a mobile phone as a telephone apparatus, while being in a mode combining the functions of a mobile phone and a hearing aid, in the known method of compensating for hearing loss in a telephone system, consisting in formation of personalized audio signals for hearing-impaired users on the basis of their attributes obtained from audiograms—hearing frequency response—of a hearing-impaired person, which are stored in a database on a communication network server and bound to phone numbers of hearing-impaired users, the said communication network server is used for processing audio signals in a broadband frequency range on the basis of attributes of a hearing-impaired user, adjusting power of audio signals processed in accordance with said attributes of the hearing-impaired user, and transmitting mentioned adjusted personalized audio signals from the communication network server to telephone apparatuses of hearing-impaired users.

Additional embodiments of the inventive method are possible, wherein it is expedient that:
in order to work in the mode combining the functions of a mobile telephone apparatus and a hearing aid, an application module for dynamic compression of audio signals on the basis of hearing attributes of a user and an application module for compensation for acoustic feedback are installed (with the use of an electronic information medium or from an Internet-connected personal computer) on the mobile telephone apparatus of a hearing-impaired user with an embedded wireless link; a signal from the microphone of a mobile telephone apparatus of an interlocutor located close to the hearing-impaired user is mixed with an audio signal received over the wireless channel from a multimedia device, the mixed audio signal is dynamically compressed by the dynamic compression module, and acoustic feedback is compensated for by the acoustic feedback compensation module, thus obtaining a broadband audio signal that is transmitted for playback on the mobile telephone apparatus of the hearing-impaired user; during a phone call on the mobile telephone apparatus of the hearing-impaired user a bit stream of the signal from the cellular network operator equipment is transmitted over bound phone numbers to the communication network server wherein the bit stream from the cellular network operator equipment is converted into a pulse-code modulation signal, and, according to this pulse-code modulation signal, a personalized audio signal is formed on the basis of its attributes; then, the communication network server encodes the personalized audio signal and forms a signal bit stream for this personalized audio signal, which is then transmitted via the communication network to the mobile telephone apparatus of the hearing-impaired user for playback;
dynamic compression is additionally performed on the communication server;
upon dynamic compression a set apparatus of sub-band audio signals is formed, and a dynamic level of every sub-band audio signal is controlled in each individual non-uniform frequency band in accordance with the hearing frequency response of the hearing-impaired user, coefficients of an algorithm used for editing environmental noise and dynamic range compression function in individual non-uniform sub-bands;
upon compensation of acoustic feedback the mixed audio signal is additionally mixed with an output signal from the acoustic feedback compensation module receiving a restored broadband audio signal from the dynamic compression module as an input signal, the mixed audio signal and the output signal from the dynamic compression module being split into separate frequency channels, adaptive filtering coefficients being evaluated for each individual frequency channel, and adaptive filtering being performed, signal of which serves as the output signal from the acoustic feedback compensation module.

The advantage of using the claimed method in mobile phones and communication systems is that the telephone function can be combined with the HA function in a mobile telephone apparatus. In contrast to conventional technical solutions, the function of editing environmental noises and suppressing acoustic feedback is introduced in addition to coefficients of audio signal dynamic compression. This enables, owing to the function of forming a personalized audio signal for hearing-impaired users of a network implemented in a communication network server without using HAs and additional devices, to improve speech intelligibility for a hearing-impaired user for comfortable communication with an interlocutor even in unfavorable acoustic conditions (in restaurants, at train stations), to exclude any feedback “whistle”, and quickly switch to a telephone conversation. The availability of a wireless link in a mobile PS and the HA functionality enables a hearing-impaired person to receive high-intelligibility TV audio signal, enjoy sound quality of a sound mini-system, etc., while eliminating environmental noise factors.

Thus, the essential features of this invention are the HA and PS functions combined in one apparatus—a mobile telephone apparatus.

Experts understand that the claimed method of compensating for hearing loss in a telephone system, which is used to form a personalized audio signal for hearing-impaired people, can be implemented with the use of various algorithms that do not change its essence being disclosed in the independent claim.

The above advantages, as well as specific features of this invention, will be explained below by its most preferred implementation option with reference to the accompanying figures.

### BRIEF DESCRIPTION OF THE SEVERAL VIEWS OF THE DRAWINGS

FIG. 1 shows a graph illustration of a range of signal perception by a person having normal hearing.

FIG. 2 shows a graph illustration the same as in FIG. 1, but for a person with impaired hearing system.

FIG. 3 shows a functional diagram of the communication system used for implementing of the claimed method.

FIG. 4 shows a functional diagram of forming a personalized audio signal for hearing-impaired users of a network by the central processing unit.

FIG. 5 shows a graph illustration of the compressor input/output characteristics.

FIG. 6 shows a graph illustration of an input signal.

FIG. 7 shows a graph illustration of the input signal of FIG. 6, as obtained upon dynamic range compression (DRC).

FIG. 8 shows a bar chart of an audio (speech) signal.

FIG. 9 shows a spectral bar chart of a DRC-processed signal.

FIG. 10 shows a graph illustration of a diagram of an input audio signal.

FIG. 11 is a graph illustration the same as in FIG. 10, after being processed by a noise editing algorithm.

FIG. 12 shows a graph illustration of an amplitude-frequency response (AFR) of an analysis filter bank.

FIG. 13 shows a graph illustration of an amplitude-frequency response (AFR) of the acoustic feedback (AFB) channel.

FIG. 14 shows group delay in the acoustic feedback (AFB) channel;

FIG. 15 shows a pattern of a frequency response of a mobile telephone apparatus used for implementing the claimed method;

FIG. 16 shows a graph illustration of an input audio signal before suppressing acoustic feedback (AFB).

FIG. 17 shows a graph illustration of an audio signal at the output of a mobile telephone apparatus loudspeaker (without AFB).

FIG. 18 shows a graph illustration of an audio signal at the output of a mobile telephone apparatus loudspeaker obtained after the input signal is processed by an algorithm for suppression of acoustic feedback (AFB).

### DETAILED DESCRIPTION OF THE INVENTION

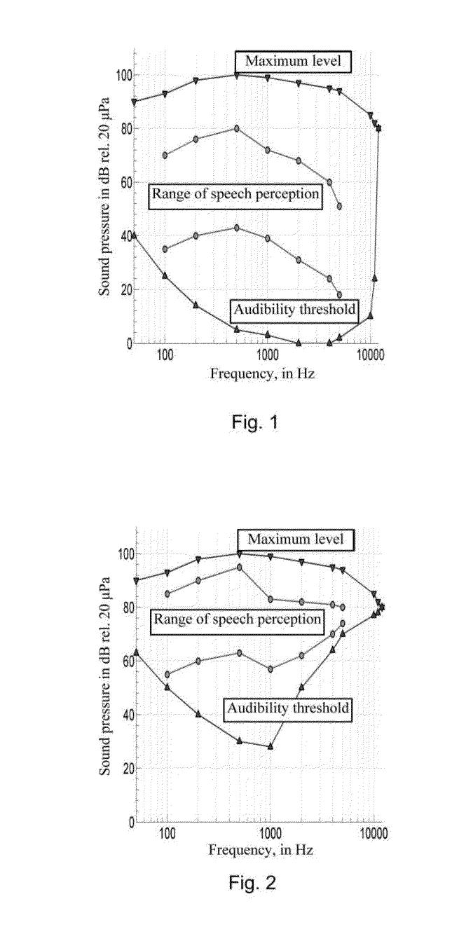

FIG. 1 shows a range of signal perception by a person having normal hearing, and FIG. 2 shows the same, but for a person with sensorineural hearing loss. The aim of modern digital hearing aids is to convert response of a hearing-impaired person (FIG. 1) into that of a person with normal hearing (FIG. 2). The main problem in designing hearing aids is limitation of allowable delay introduced into an audio signal. At a great delay (more than 8 milliseconds) a parasitic echo appears that has a negative influence on perception. Modern hearing aids perform the processing in signal frequency sub-bands, which requires using analysis and synthesis filter banks that introduce additional group delay and may not ensure a delay less than 6-8 milliseconds. Moreover, when using an HA and a PS separately, problems that have been described in the prior art arise.

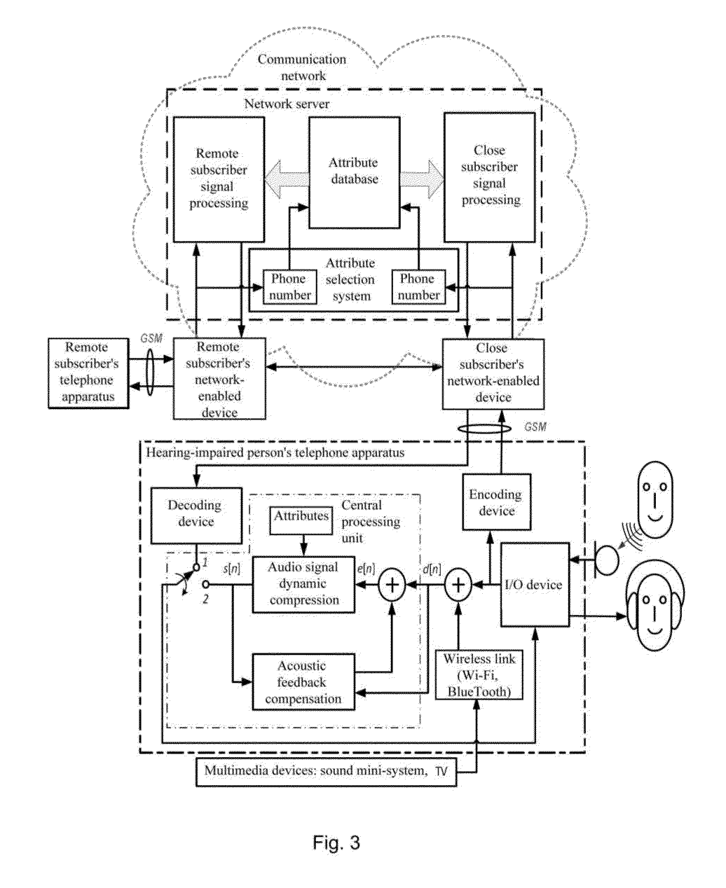

The claimed method of compensating for hearing loss in a telephone system and in a mobile telephone apparatus may be implemented with the use of the devices depicted in the functional diagram shown in FIG. 3.

The claimed method may be implemented in a communication network consisting of a PS of a close subscriber and a remote subscriber, i.e., a mobile telephone apparatus (MTA) of an hearing-impaired user, PS data network-enabled devices, as well as a communication network server comprising an attribute database for hearing-impaired users, software for processing signals from the close subscriber and the remote subscriber, and a system for selecting attributes according to the phone number of a hearing-impaired subscriber.

The MTA in this invention is understood as any programmable personal communication device, e.g., a smartphone, iPhone, or iPad; and phone numbers are understood as any user identification signs, for example those used in voice communication under the IP-protocol, e.g., “Skype”, etc.

In order to operate an MTA according to the first option, i.e., in the mode of a hearing aid (HA), the application module (software) for audio signal dynamic compression on the basis of hearing attributes of a user which are obtained from audiograms of a hearing-impaired user, and a module for acoustic feedback compensation are to be installed on an existing MTA with an embedded wireless link with the use of an electronic information medium or from an Internet-connected personal computer.

When operated in the HA mode, the switch is in Position 2 (FIG. 3). An MTA is turned ON, and a wireless communication link is connected for listening to multimedia devices (such as a sound mini-system, TV-set, etc.). A signal from the wireless communication link enters the input of the audio signal dynamic compression module and is double-mixed (by software). Surrounding noise enters the first mixing device from the microphone of the MTA through an I/O device made on the basis of an analog-to-digital converter (ADC) and a digital-to-analog converter. A d[n] signal is transmitted from the output of the first mixing device to the first input of the acoustic feedback (AFB) compensation module and to the first input of the second mixing device to the second input of which a signal from the output of the AFB compensation module is fed. A e[n] signal after second mixing is transmitted to the input of the audio signal dynamic compression module where it is processed for narrowing a dynamic range in accordance with attributes (audiogram) of a hearing-impaired user. A restored signal s[n] from the output of the audio signal dynamic compression module (the restoration unit (not shown) is at the output of the dynamic compression module and serves for restoring broadband operation) is fed to the second input of the AFB compensation module and to the input of the I/O device for playback through the MTA loudspeaker (primarily, through headphones of a hearing-impaired user). The acoustic feedback compensation module is constructed on the basis of two filter banks for AFB analysis, one filter bank for AFB synthesis, and a unit for signal sub-band processing and is designed for suppression of acoustic feedback.

In order to operate an MTA according to the second option, i.e., in the mode of a hearing aid (HA), an interlocutor who is close to a hearing-impaired user talks to the latter. An audio (speech) signal from the microphone output is transmitted with environmental noise through the I/O device to the first mixing device; therefore, a main input audio signal is formed for the dynamic compression module by mixing the microphone signal with an audio signal received from a multimedia device via the wireless communication link. Then, the operation is continued according to the first option. A hearing-impaired user can listen, without interruption, to both interlocutor's phrases and music sounds, e.g., from a sound mini-system.

If a telephone call is coming, the hearing-impaired user of the MTA turns the switch into Position 1 (FIG. 3), The MTA is connected to a cellular communication network and is operated in the telephone mode.

Taking into account that the designers of the operating system for an MTA of iPhone type do not provide the possibility of accessing a GSM codec (primarily, for safety reasons), a bit stream in a channel (e.g., GSM) is intercepted by a communication network server according to a respective phone number (FIG. 3) from the mobile communication operator equipment (a service provided by cellular network operators). The communication network server converts the bit stream of a signal from the cellular network operator equipment into a pulse-code modulation (PCM) signal. The PCM signal is further processed in accordance with software installed on the server to form a personalized audio signal for hearing-impaired users on the basis of their attributes obtained from audiograms stored in a database on the communication network server and bound to phone numbers of those hearing-impaired subscribers. The communication server processes audio signals in a broadband frequency range on the basis of a function that is inverse to the frequency response of ahearing-impaired user, amplifies and/or delimits power of the processed audio signals in accordance with the function that is inverse to the frequency response of the hearing-impaired user for the purpose of maintaining moderate volume. After being processed in the communication server, a signal PCM-code is formed with due regard to the pathology of the hearing-impaired user. Then, this code is encoded by a GSM-encoder and transmitted to a network-enabled device, and then the MTA receives this bit stream from the communication network channel (the MTA transceiver is not shown in FIG. 3 for clarity), decodes it in the decoder, then the decoded signal is passed to the input of the I/O device, and the speech signal is played back through the MTA loudspeaker (headphones).

Depending on the fact who of the subscribers—whether close one or remote one—has impaired hearing, embodiments of the method are possible with implementation of the telephone mode.

If the MTA is operated according to the third option, i.e., in the telephone apparatus mode, a remote subscriber has normal hearing, and a close subscriber has impaired hearing. In this case, a speech signal is transmitted in the common mode through the MTA encoder to the network-enabled device of the close subscriber, bypassing the communication server, and further to the PS of the remote subscriber via the communication network with the use of the cellular communication operator equipment and via the network-enabled device of the remote subscriber. An audio signal from the remote subscriber is transmitted to the network server through the network-enabled device on the basis of the phone number of the hearing-impaired subscriber (i.e. close subscriber). The communication server performs dynamic compression of the remote subscriber's signal according to the attributes from an audiogram of the close subscriber, the audiogram being selected from the attribute database in accordance with the phone number of the close subscriber. Then, the processed and restored signal of the remote subscriber is transmitted through the network-enabled device to the network-enabled device of the close subscriber via the communication network. As described above, the MTA of the close subscriber receives this bit stream from the communication network channel and decodes it by the decoder. The decoded signal is passed to the I/O device input, and the speech audio signal of the remote subscriber is played back through the MTA loudspeaker (headphones).

If the MTA is operated according to the fourth option, i.e., in the telephone apparatus mode, a close subscriber and a remote subscriber both have impaired hearing. In this case speech signals of the close subscriber and the remote subscriber are transmitted through their respective network-enabled devices to the communication network server where these signals are dynamically compressed according to attributes of an audiogram of the remote subscriber (for the speech signal of the close subscriber) and attributes of an audiogram of the close subscriber (for the speech signal of the remote subscriber), which s are selected from an attribute database in accordance with the phone numbers of the remote subscriber and the close subscriber. Then, the processed signals that are restored through the respective network-enabled devices are transmitted via the communication network to the MTAs of both subscribers.

If the MTA is operated according to the fifth option, i.e., in the mode of a telephone conversation, communication with a close interlocutor, listening to an audio signal from external multimedia devices received from multimedia software installed in the MTA and intended for playback of audio files, radio, etc., the user turns the switch simultaneous into Position 1 and 2. This implements all the above-described four mode embodiments. Therefore, the user is able to receive a personalized audio signal, while simultaneously communicating with another subscriber over the phone and with an interlocutor in person, and receiving an audio signal from loudspeakers of various devices, e.g., during watching TV programs, listening to music, etc.

Experts understand that, by using the switch, the user is able to control the modes of telephone conversation, personal communication with an interlocutor, reception of an audio signal from loudspeakers and multimedia devices.

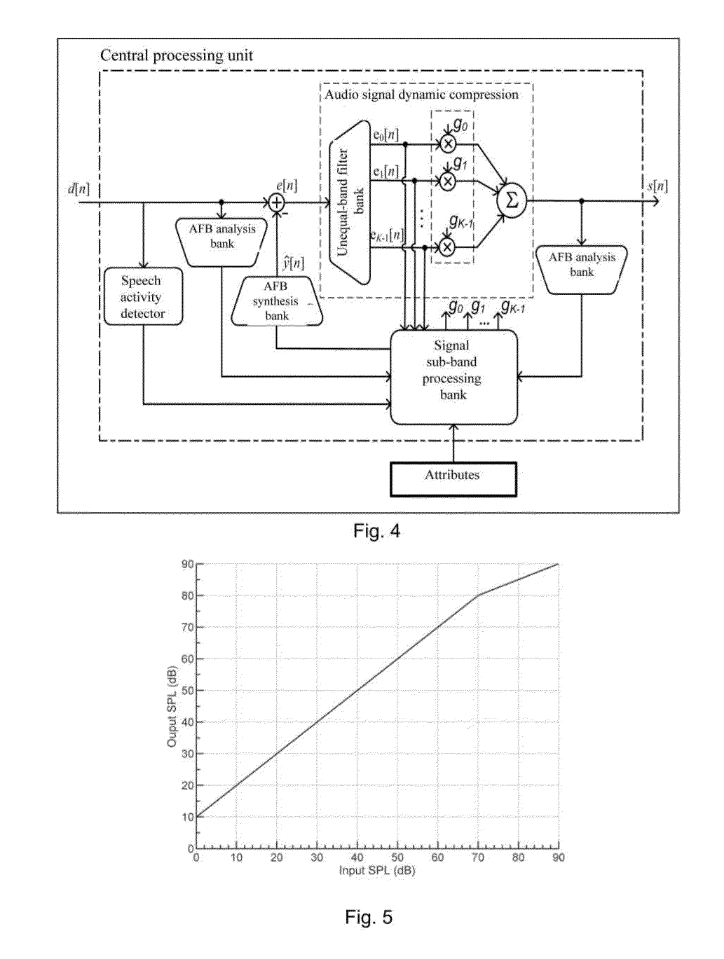

In order to form a personalized signal for a hearing-impaired user, the central processing unit of his or her MTA works as follows (FIG. 4).

The MTA central processing unit forms a personalized audio signal, using software for audio signal dynamic compression that comprises an unequal-band filter bank, channel multipliers by correcting gain factors, an output adder for restoring signal broadband response; software for acoustic feedback compensation on the basis of sub-band adaptive filtering, which application module comprises two filter banks for AFB analysis, a filter bank for AFB synthesis (for brevity they are shown in FIG. 4 as the AFB analysis unit and the AFB synthesis unit), a unit for signal sub-band processing that evaluates and renews adaptive filtering coefficients, measures noise power spectral density on the basis of a stochastic evaluation of whether a pause in speech is present by a speech activity detector application, and calculates weight coefficients for the algorithm of editing environmental noise.

A d[n] signal (see FIGS. 1, 3) is transmitted from the output of the first mixing device to the input of the speech activity detector, to the input of the first filter bank for AFB analysis and to the first input of the second mixing device to the second input of which a y[n] signal is transmitted from the first output of the filter bank for AFB synthesis. A e[n] signal is transmitted from the output of the second mixing device to the input of the unequal-band filter bank. Signals from the outputs of the speech activity detector and the first filter bank for AFB analysis, are transmitted, respectively, to the first and second inputs of the signal sub-band processing unit. The unequal-band filter bank has K outputs at which signals e0[n] . . . eK−1[n] from each bank filter are received. These signals are transmitted to the respective inputs of the signal sub-band processing unit. The signal sub-band processing unit calculates sub-band gain factors g0 . . . gK−1. The e0[n] . . . eK−1[n] and g0 . . . gK−1 are transmitted, respectively, from the data outputs of the unequal-band filter bank and from the data outputs of the signal sub-band processing unit to the first and second inputs of the mixing devices set which are connected, respectively, to the inputs of the multi-input adder serving for restoring broadband response from the output of which an s[n] signal is obtained for its playback at the MTA of a hearing-impaired user. The adder output is connected to the second AFB analysis unit the output of which is connected to the third input of the signal sub-band processing unit. The output of the signal sub-band processing unit is connected to the input of the AFB synthesis unit. Data on attributes corresponding to the audiogram of a particular user is entered into the signal sub-band processing unit.

A d[n] signal (see FIGS. 1, 3) is transmitted from the output of the first mixing device to the input of the speech activity detector, to the input of the first bank for AFB analysis and to the first input of the second mixing device to the second input of which a y[n] signal is transmitted from the first output of the bank for AFB synthesis. An e[n] signal from the output of the second mixing means is transmitted to the input of the unequal-band filter bank. Signals from the outputs of the speech activity detector, the first bank for AFB analysis and from the second output of the bank for AFB synthesis are transmitted, respectively, to the first, second and third inputs of the signal sub-band processing unit. The unequal-band filter bank has K outputs at which e0[n] . . . eK−1[n] signals are transmitted from every filter contained in the bank. These signals are transmitted to the corresponding data inputs of the signal sub-band processing unit. The signal sub-band processing unit calculates sub-band gain factors gK. Counts of e0[n] . . . eK−1[n] channel signals and factors g0 . . . gK−1 are transmitted, respectively, to the first and second inputs of channel multipliers by correcting gain factors, the outputs of said multipliers being connected, respectively, to the inputs of the multi-input adder serving for restoring broadband response from the output of which an s[n] signal is obtained for its playback by the MTA of the hearing-impaired user. The adder output is connected to the input of the second unit for AFB analysis the output of which is connected to the third input of the signal sub-band processing unit. Data on attributes corresponding to the audiogram of a particular user are entered into the signal sub-band processing unit.

The signal sub-band processing unit controls: a signal level in respective sub-bands in order to provide required dynamics of sub-band signal levels that are conditioned by the audiogram (attributes) of the hearing-impaired user of the MTA; coefficients of the algorithm of editing environmental noise; and a function used for dynamic range compression in respective sub-bands that are integrated into respective sub-band gain factors gK.

Dynamic range compression (DRC) is used to decrease a difference in levels of components having high and low intensity in an audio signal. Thus, a broad dynamic range of a speech signal is transformed into a narrowed dynamic range of residual hearing.

The present method utilizes as an unequal-band filter bank a filtering pattern with a small (less than 4 milliseconds) group delay on the basis of a cochlear filter bank that is implemented as a set of parallel band filters with an infinite-impulse response (IIR) of second order. The cochlear filter bank possesses several important and desired properties, such as: 1) signal is decomposed into critical bands of the human hearing system; 2) low (less than 4 milliseconds) group delay; 3) high computational efficiency (filtering in each channel is performed by using an IIR-filter of second order). This technical solution uses 22-channel filter bank based on a differential cochlear model of second order.

In accordance with available threshold values of a hearing-impaired user's attributes, the signal sub-band processing unit calculates correcting gain factors for a g0 . . . gK−1 signal in every sub-band.

Then, the compression algorithm is used, since an output signal dynamic range is limited by a pain threshold. The main idea of the dynamic range compression (DRC) algorithm is automatic control of gain factors, depending on a current level of an input signal. The DRC main parameters are the input/output function and the times of attack and restoration.

Signals of high power in sub-bands are attenuated, and those of low power are amplified. Due to such processing, low sounds become audible, and loud sounds do not cause discomfort sensations. Thus, DRC consists in automatic control of gain factors, depending on an input signal current level. The DRC main parameters are: compression threshold (CT); compression ratio (CR); times of attack and release; hearing aid gain (GdB). Compression threshold (CT) measured in decibels defines a bend point of compressor input/output characteristic, after which the DRC algorithm becomes active. If an input signal level is lower than CT, then an output signal will be amplified linearly. In a case where an output signal level is higher than compression threshold (CT), a compressor gain will be decreased. The CR parameter defines a dynamic range compression ratio. For example, the CR value of 5 (or 5:1) means that per every 5 dB of increase in an input signal level, an output signal level will be increased only by 1 dB. FIG. 5 shows the compressor input/output characteristics for the parameters CR=2, CT=70 dB and GdB=10 dB. This graph defines relation between input and output levels of sound pressure (SPL=sound pressure level) in a compressor.

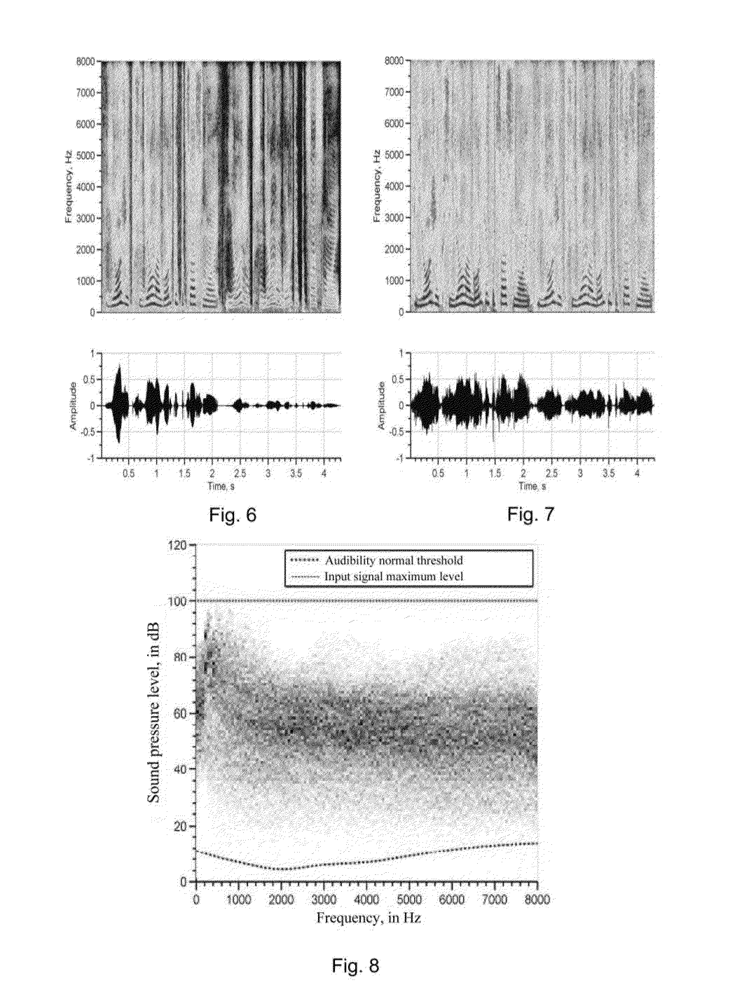

FIGS. 6 and 7 show an example of input signal processing result (FIG. 6) consisting of two portions—loud and low regions—obtained with the use of the DRC algorithm (FIG. 7).

An effect of non-linear amplification is clearly seen (both portions are nearly balanced by volume (FIG. 7)). Distortions, seen in the spectrum after processing appear as a result of non-linear processing in the compressor; but they do not significantly influence speech intelligibility and recognizability of the speaker.

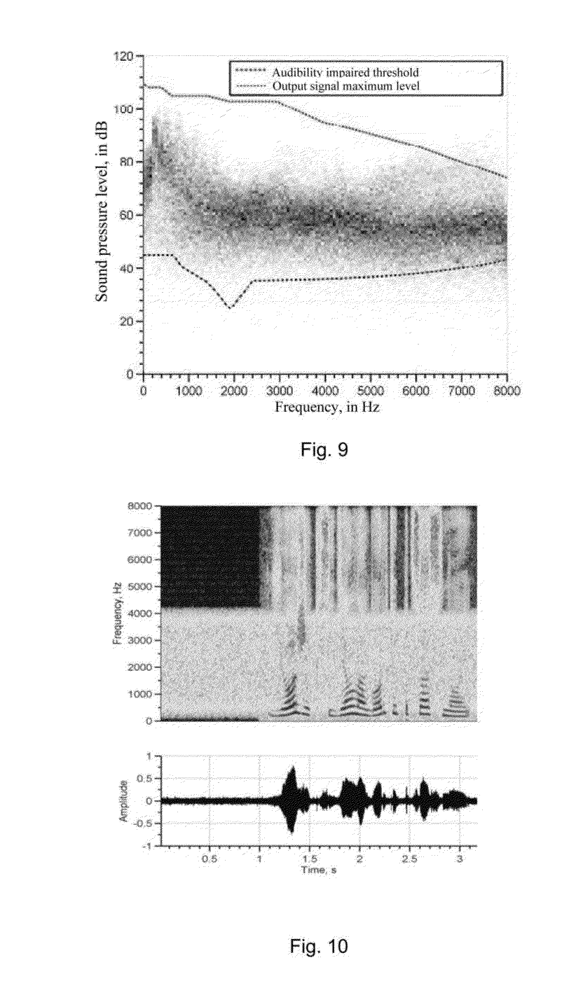

A test speech signal (FIG. 8) was processed with the use of the DRC algorithm adjusted for a particular hearing loss profile. The spectral bar chart obtained after processing of the signal is shown in FIG. 9. The results show that the DRC algorithm enables to adapt an output signal level to a hearing response of a hearing-impaired user.

The algorithm used for editing environmental noise is based on the psycho-acoustically motivated rule of spectral weighting. The algorithm uses the adjustable parameter ζ=10^{-RL/20} that determines a desirable level of residual noise RL in dB. Noise power spectral density (PSD) is evaluated for each channel of the DRC algorithm by using a calculation-efficient and error-tolerant algorithm based on the modified MCRA (Minima Controlled Recursive Averaging) method. A current PSD value for noise, Rn (where n is a count number), is calculated by way of averaging previous PSD values, Re(n), by using smoothing parameters depending on the possibility of having a useful signal that is determined by a speech activity detector using, for example, the cepstrum analysis. The parameters are refreshed every 4 milliseconds.

Also, similar dynamic compression may be carried out on a communication server, but without compensating for AFB and noise reduction.

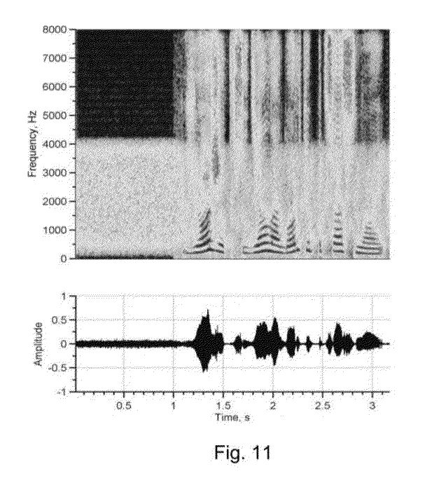

FIGS. 10 and 11 show results of using the algorithm of editing environmental noise: FIG. 10 shows a signal at the microphone input, FIG. 11 shows a signal after processing.

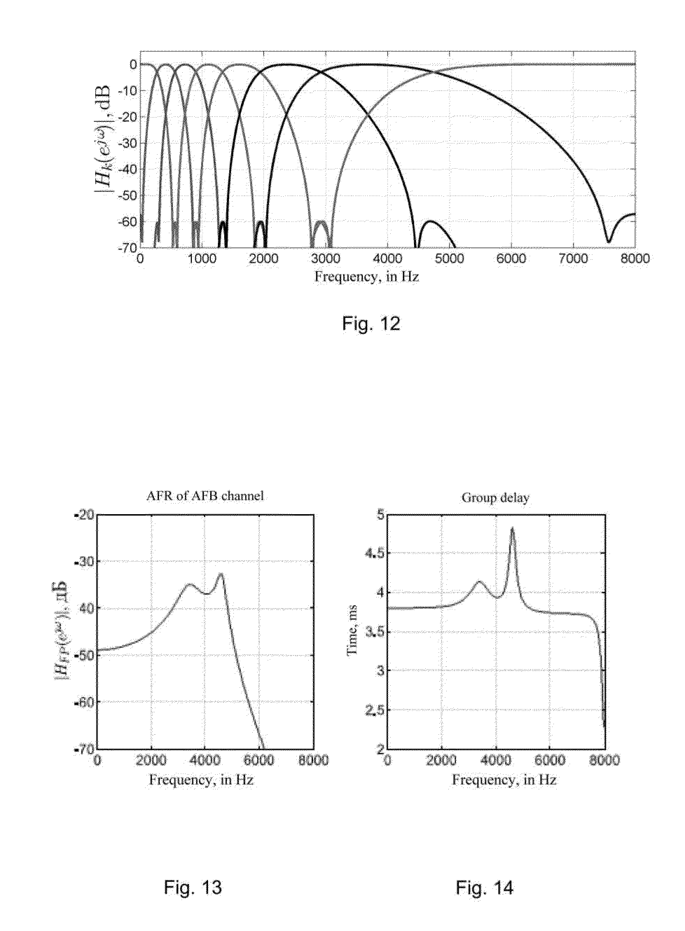

Acoustic feedback suppression can be performed as follows (FIG. 4). A d[n] signal is split into M spectral components at the DRC input with the use of the first filter bank for AFB analysis. The second bank for AFB analysis, which is similar to the first one, is used for splitting a s[n] signal into M spectral components at the DRC output. Since signal spectra within channels occupy narrower frequency bands, a transition to a lower sampling frequency is performed. A source sampling frequency is restored in the filter bank for AFB synthesis. The signal sub-band processing unit (FIG. 20) evaluates its own vector of adaptive filter coefficients. The latest results in the field of adaptive filtering show that unequal-band adaptive structures are better than equal-band ones in some parameters, such as convergence rate and/or model error, due to their higher flexibility. For sub-band decomposition of a signal, the technical solution uses an oversampled unequal-band cosine-modulated filter bank (CMFB) amplitude-frequency characteristic of which is shown in FIG. 12.

An individual set of adaptive filter coefficients is evaluated in each channel. The evaluation procedure is similar for all channels and differs only in parameter values, such as order of filter, loss factor and adaptation step. Coefficients are refreshed on the basis of the least-squares algorithm (for simplification of record, channel number index is omitted):
1. Zero value is assigned to each filter coefficient w[I], I=0, 1 . . . L−1, where L is order of the adaptive filter.

2. A filter output count is calculated:

ŷ[m]=Σₗ₌₀^{L-1}w[l]s[m−l],

where m is the number of an input signal current count, and s[m] is an input signal.
3. Error evaluation is calculated: e[m]=d[m]−y[m], where d[m] is a desired signal.
4. Weight coefficients are refreshed: w[I]=ζw[I]+2μe[m]×[m−l], where 0<ζ<1 is loss factor. The μ parameter is an algorithm adaptation step. The number of a current count is increased: m=m+1. The algorithm moves to step 2.

FIGS. 13 and 14 show frequency responses of a simulated channel of acoustic feedback.

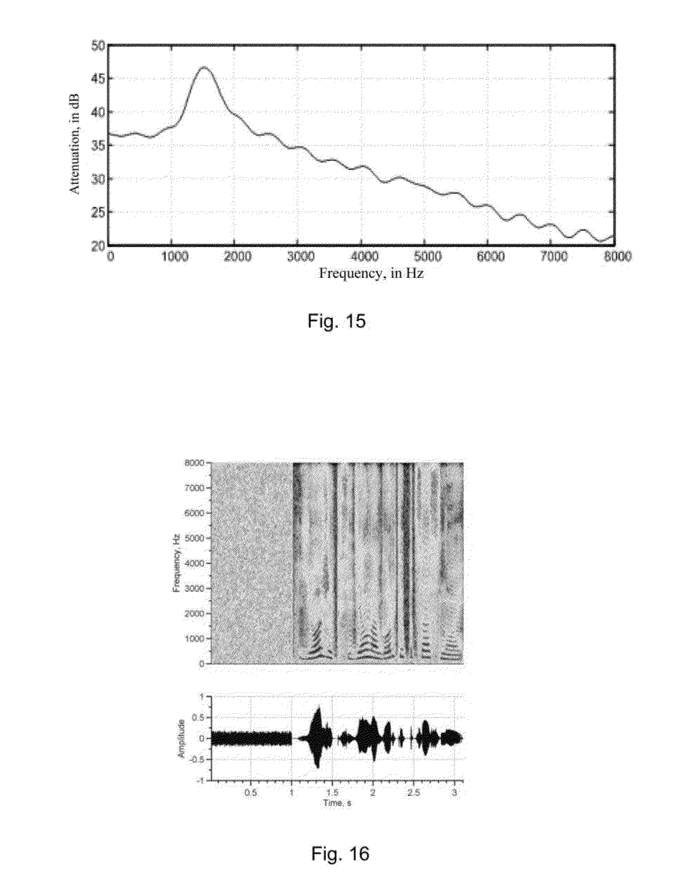

In order to simulate a direct channel, i.e., that for signal processing in a MTA, an averaged AFR is selected (FIG. 15) that compensates for a typical damage of the hearing system. Most losses take place in the region of 1.5 kHz, i.e. in the frequency range where speech is most informative.

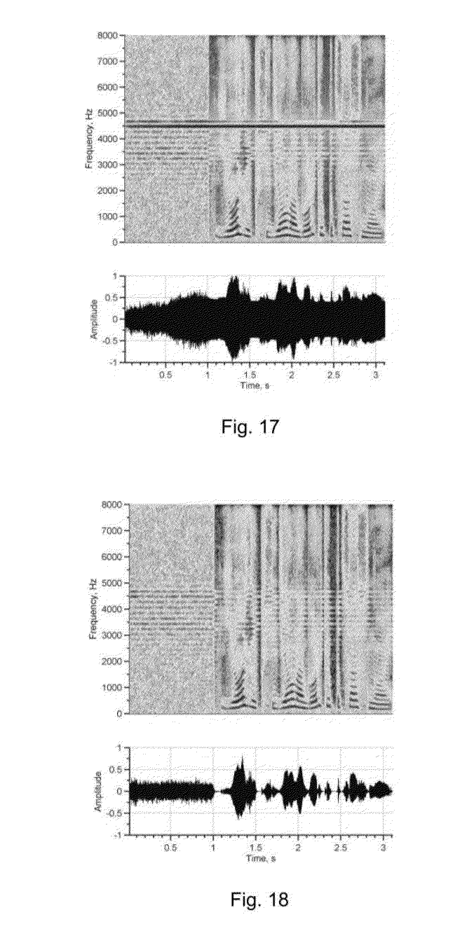

FIGS. 16, 17, 18 show results of the AFB module operation: FIG. 16 shows an input audio signal, FIG. 17 shows an audio signal at the loudspeaker output; system excitation at a frequency of about 5,000 Hz is clearly seen, FIG. 18 shows a result of processing an input audio signal with the algorithm of suppressing acoustic feedback. It can be seen from the given spectrograms that the use of the algorithm of AFB suppression enables to use higher gain factors for processing a signal in a direct channel, which leads to improvement in speech intelligibility for a hearing-impaired user.

### INDUSTRIAL APPLICABILITY

The claimed method of compensating for hearing loss in a telephone system and in a mobile telephone apparatus may be most beneficially applied in the industry as a multimedia application for people suffering from sensorineural hearing loss.

1. A method of compensating for hearing loss in a telephone system, the method comprising the steps of:
forming personalized signals for hearing-impaired users on the basis of their attributes stored in a database on a communication network server and bound to phone numbers of hearing-impaired users;
processing audio signals with an communication server in a broadband frequency range on the basis of attributes of a hearing-impaired user;
adjusting power of processed signals in accordance with mentioned attributes of said hearing-impaired user; and
transmitting adjusted personalized audio signals from the communication server to telephone apparatuses of hearing-impaired users,
wherein a cellular network is used as said communication network, and
wherein a mobile telephone apparatus is used as said telephone apparatus, a mode combining functions of a mobile telephone apparatus and a hearing aid being applied, a cellular network being used as said communication network, and a mobile telephone apparatus being used as said telephone apparatus, the mode of a telephone apparatus being used for a subscriber having normal hearing and for a hearing-impaired subscriber,
wherein an audiogram is comprised of a frequency response of hearing of said hearing-impaired user and is used as attributes of said hearing-impaired user, and
wherein the mobile telephone apparatus operates in:
hearing aid mode for listening to multimedia devices by said hearing-impaired user,
hearing aid mode for communicating with a human interlocutor being close to said hearing-impaired user,
telephone apparatus mode for hearing-impaired people.

2. The method according to claim 1, wherein application modules for dynamic compression of audio signals on the basis of hearing attributes of a user and for compensation for acoustic feedback are installed on the mobile telephone apparatus of a hearing-impaired user with an embedded wireless link;
wherein a signal from the microphone of a mobile telephone apparatus of a human interlocutor located close to the hearing-impaired user is mixed with an audio signal received over the wireless channel from a multimedia device;
wherein the mixed audio signal is dynamically compressed in the dynamic compression module, and acoustic feedback is compensated for in the acoustic feedback compensation module, thus obtaining a broadband audio signal that is transmitted for playback on the mobile telephone apparatus of the hearing-impaired user;
wherein, in case a call is received on the mobile telephone apparatus of the hearing-impaired user, a bit stream of a signal from cellular network operator equipment is transmitted over bound phone numbers to the communication network server,
wherein the bit stream from the cellular network operator equipment is converted into a pulse-code modulation signal, and, according to this pulse-code modulation signal, a personalized audio signal is formed on the basis of its attributes; and
wherein, then, the communication network server encodes the personalized audio signal and forms a signal bit stream for this personalized audio signal, the bit stream of which is then transmitted via the communication network to the mobile telephone apparatus of the hearing-impaired user for playback.

3. The method according to claim 2, wherein, upon dynamic compression, a set of sub-band audio signals is formed, and a dynamic level of every sub-band audio signal is controlled in each individual non-uniform frequency band in accordance with the hearing frequency response of the hearing-impaired user, coefficients of an algorithm used for editing environmental noise and dynamic range compression function in individual non-uniform sub-bands.

4. The method according to claim 2, wherein, upon compensation of acoustic feedback the mixed audio signal is additionally mixed with an output signal from the acoustic feedback compensation module receiving a restored broadband audio signal from the dynamic compression module as an input signal, the mixed audio signal and the output signal from the dynamic compression module being split into separate frequency channels, adaptive filtering coefficients being evaluated for each individual frequency channel, and adaptive filtering being performed the signal of which serves as the output signal from the acoustic feedback compensation module.

5. The method according to claim 1, wherein said modes are applied either separately or simultaneously.
